(19) United States
(12) Patent Application Publication
(10) Pub. No.: US 2017/0142177 A1
(43) Pub. Date: May 18, 2017

(54) METHOD AND SYSTEM FOR NETWORK DISPATCHING

(71) Applicants: LE HOLDINGS (BEIJING) CO., LTD., Beijing (CN); LECLOUD COMPUTING CO., LTD., Beijing (CN)

(72) Inventor: Chaoping HU, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,393

(22) Filed: Aug. 31, 2016

Related U.S. Application Data
(63) Continuation of application No. PCT/CN2016/083189, filed on May 24, 2016.

(30) Foreign Application Priority Data
Nov. 13, 2015 (CN) 201510781328.6

(51) Int. Cl. H04L 29/06; H04L 29/08

(52) U.S. Cl. CPC H04L 65/4084; H04L 67/1002; H04L 67/18; H04L 67/1097; H04L 65/80

(57) ABSTRACT

Disclosed is a method for network dispatching and electronic device. The method includes: determining a service quality level of all edge nodes serving for a partition with respect to a video according to historical data of a blockage ratio and slow speed ratio in accessing the video in the partition; establishing a mapping model between a user's priority and the service quality level; receiving a request from the user in the partition for accessing the video and determining the priority of the user; dispatching an edge node having a corresponding service quality level for the user based on the determined priority of the user and the mapping model. Accordingly, edge nodes being able to provide excellent service can be quickly selected by the video accessing user based on historical access data, which guarantees the service quality and improves the user experience.

### CROSS REFERENCE TO RELATED APPLICATIONS

This application is a continuation of International Application No. PCT/CN2016/083189, filed on May 24, 2016, which is based upon and claims priority to Chinese Patent Application No. 201510781328.6, filed on Nov. 13, 2015, the entire contents of which are incorporated herein by reference.

### TECHNICAL FIELD

The disclosure relates to the field of Internet, in particular, to a method for network dispatching, an electronic device and a non-transitory computer-readable storage medium.

### BACKGROUND

CDN (Content Delivery Network) is a layer of an intelligent virtual network based on the existing Internet composed by placing node servers throughout network, mainly including a hunt edge (edge node) and a back source station (a back source path). CDN can redirect a user's request onto a service node which is nearest the user in real time according to network traffic and connections of each node, load status and distance to the user, response time and other comprehensive information, etc., which aims to send the desired content to the user by selecting a node that is relatively close to the user, to ease network congestion condition and improve the response speed of the site.

In the prior art, when a user accesses to video resources, a dispatching center needs to teed an address of an edge node buffering accessed video resources back to the user. Then the user obtains corresponding video from the edge node buffering accessed video resources. When the dispatching center found that a plurality of edge nodes buffer accessed video resources, it can select an edge nearest the user's location (the geographic location, such as a service computer room closest to the user), and feeds the address of the nearest edge node back to the user, so that the user obtains the video from the edge node.

The prior art only considers the edge node closest to the user's geographic location, and does not consider the impact of network conditions between the user and the edge node for the user accessing the video. However, due to ignoring of the fact that the network conditions between the edge node and the user are cannot be obtained, there will be certain blockage ratio and slow speed ratio which affect the user experience, so a geographically nearest edge node does not necessarily provide the best service quality. In addition, the prior art cannot provide users with a personalized on-demand service.

### SUMMARY

The present application provides a method for network dispatching, an electronic device and a non-transitory computer-readable storage medium to solve the defect that the prior art can only provide geographically nearest edge node for the user, but cannot guarantee to provide users with the best service quality edge node; in other aspect, and cannot solve the defect that providing users with the personalized on-demand service.

According to an aspect of the present application, there is provided a method for network dispatching , including:

determining a service quality level of all edge nodes serving for a partition with respect to a video according to historical data of a blockage ratio and slow speed ratio in accessing a video in a partition;

establishing a mapping model between a user's priority and the service quality level;

receiving a request from a user in the partition for accessing a video and determining the priority of the user; and

dispatching an edge node having a corresponding service quality level for the user based on the determined priority of the user and the mapping model.

According to another aspect of the present application, there is further provided a non-transitory computer-readable storage medium storing executable instructions that used to execute any one of methods of the present application as described above.

According to yet another aspect of the present application, there is further provided an electronic device, the device includes at least one processor and a memory for storing instructions executable by the at least one processor, wherein execution of the instructions by the at least one processor causes the at least one processor to execute any one of methods of the present application as described above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for network dispatching according to an embodiment of the present application;

FIG. 2 is a flow chart for determining service quality level of edge node according to an embodiment of the present application;

FIG. 3 is a schematic diagram of a system for network dispatching according to an embodiment of the present application;

FIG. 4 is a schematic diagram for determining service quality level of edge node according to an embodiment of the present application;

FIG. 5 is a schematic diagram of a service quality level determination unit according to an embodiment of the present application;

FIG. 6 is a schematic diagram of a mapping model generation module according to an embodiment of the present application;

FIG. 7 is a schematic diagram for implementing the method and system for network dispatching according to an embodiment of the present application; and

FIG. 8 is a structural schematic diagram of an electronic device for implementing the method for network dispatching according to an embodiment of the present application.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

It should be noted that, embodiments of the present application and the technical features involved therein may be combined with each other in case they are not conflict with each other.

The present application is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The present application can be described in a general context where a computer executes computer-executable instructions, such as program modules. Typically, program modules include routines, programs, objects, components, data structures, etc. which perform certain tasks or implement certain abstract data types. The present application can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “comprise”, “comprising”, and the like are to be construed as including not only the elements described, but also those elements not specifically described, or further comprising elements which are essential to such process, method, article or device. Unless the context clearly requires, throughout the description and the claims, elements defined by recitation with “comprising . . . ” should not be construed as exclusive from the process, method, article or device comprising said elements of other equivalent elements.

As shown in FIG. 1, a method for network dispatching according to an embodiment of the present application includes the following steps.

In S1, the dispatch center determines a service quality level of all edge nodes serving for a partition with respect to a video according to historical data of a blockage ratio and a slow speed ratio for a user in a partition accessing the video.

In S2, the dispatch center establishes a mapping model between a user's priority and the service quality level.

In S3, the dispatch center receives a request from the user in the partition accessing the video and determines the priority of the user.

In S4, the dispatch center dispatches an edge node having a corresponding service quality level for the user based on the determined priority of the user and the mapping model.

The dispatching center (i.e., a server or server cluster in this embodiment) classifies priority of edge nodes for serving the video by partition to make the network dispatching more pertinent. Moreover, edge node whose priority corresponds to the user's priority is assigned to meet individual needs, thus ensuring a better user experience.

The partitions in the embodiment of the present application can be, for example, the partitions of the geographical location, which can be divided based on units of residential area, or units of business district, or units of administrative regions (for example, Beijing Region, Shanghai Region).

The above-described embodiment also include: the dispatching center receives historical data of a blockage ratio and slow speed ratio that the user accesses the video in all partitions, and firstly divides all historical data in accordance with partitions, then divides all data in each partition in accordance with the accessed video, thereby obtaining historical data of a blockage ratio and slow speed ratio for every users in the partition accessing one video.

The historical data of a blockage ratio and slow speed ratio that the user accesses the video through an intelligent terminal are in a predetermined period which is preferably three months. The real-time and effectiveness of data can be ensured by using the historical data of recent three months. Meanwhile, the burden on the processor for processing data is also reduced. Because the network environment in all regions and software and hardware resources are continuously updated, too old historical data does not have reference value, so the data of recent three months is used. Of course, it is not limited to the recent three months as the period can be adjusted longer or shorter according to the actual needs.

In fact, the user access request information includes at least user's location information, accessing video information and user information, and the user information at least includes user sources information, user attribute information, and network service provider information. The dispatching center of the embodiment determines the partition to which the user belongs according to the geographic location information, determines the accessed video according to the accessing video information, and then determines the level of the user's priority based on the user sources information and user attribute information. The user attribute information at least includes members and non-member users, and the user sources information at least includes intelligent terminal and client.

The intelligent terminal may be a mobile phone (for example, a Letv phone), and can also be a portable, pocket-sized, handheld computer built or car-mounted mobile devices, it can be PC (personal computer), tablet, etc., but also may be able to connect to the Internet smart TV (for example, a Letv super TV), set-top boxes, and thus smart terminal can achieve the collection of natural information targets to be identified.

When the user's attribute is the member user (such as subscribers), an edge node of high service quality can be obtained preferentially in the edge node dispatching. When the dispatching center identifies the user sources information is the Letv TV or Letv phone, or Letv client (for example, Letv APP), the edge node of high service quality can also be obtained preferentially in the edge node dispatching, which can guarantee the different services to the users with different priorities, assure service quality and enhance the user experience.

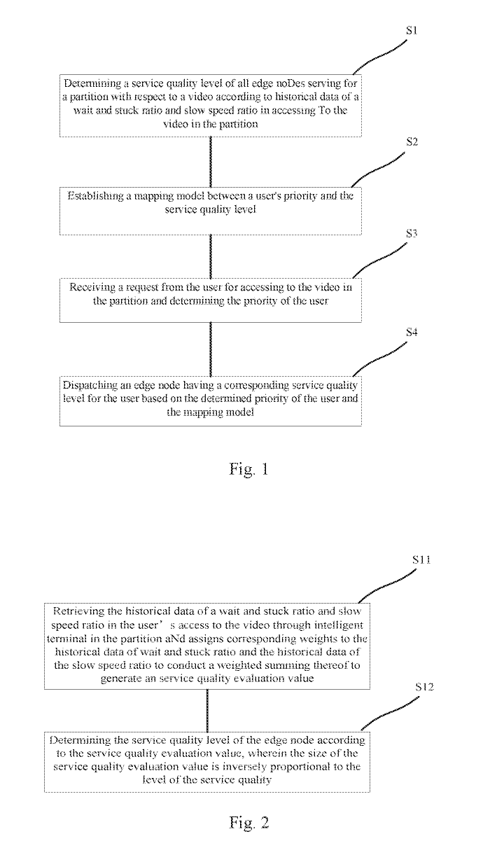

As shown in FIG. 2, in some embodiments, in S1, the dispatching center determines a service quality level of all edge nodes serving for a partition with respect to a video according to historical data of a blockage ratio and slow speed ratio in accessing the video in the partition, which includes the following steps.

In S11, the dispatching center retrieves the historical data having a blockage ratio and slow speed ratio for the user in the partition accessing the video through intelligent terminal and assigns corresponding weights to the historical data of blockage ratio and the historical data of the slow speed ratio. Then a weighted summing is conducted on these data to generate a service quality evaluation value.

In S12, the dispatching center determines the service quality level of the edge node according to the service quality evaluation value, wherein the service quality evaluation value is inversely proportional to the level of the service quality.

The dispatching center in the above-described embodiment determines level of quality service of the edge node providing video service by a weighted summing of historical data of a blockage ratio and slow speed ratio for the user accessing the video and a comparison. Since the dispatching center in the present embodiment determines whether the service quality of edge node is good or bad directly from the data information of user experience, the obtained evaluation of the service quality of the edge node is more reliable. Even if there are other factors affecting the user experience, the final manifestation impacting the user experience still ascribe to the blockage ratio and slow speed ratio. Therefore, the evaluation on service quality of the edge node obtained directly from the blockage ratio and slow speed ratio is objective and reliable.

In some embodiments, the dispatching center quantitatively determines service quality of the edge node providing service by setting a first threshold value range, a second threshold range, and a third threshold range, and according to the weight of the blockage ratio and the slow speed ratio when watching video and a range interval in which the weight falls.

Specifically, the dispatching center determines the service quality level of the edge node according to the service quality evaluation value in S11 includes the following steps.

When the service quality evaluation value falls within a first threshold value range, the edge node is determined as a first level edge node.

when the service quality evaluation value falls within a second threshold value range, the edge node is determined as a second level edge node.

when the service quality evaluation value falls within a third threshold value range, the edge node is determined as a third level edge node.

The smaller the weighted sum of the blockage ratio and slow speed ratio, the higher the quality of service provided by the edge node.

An upper limit value of the first threshold value range is smaller than a lower limit value of the second threshold range, and an upper limit value of the second threshold value range is smaller than a lower limit value of the third threshold range.

The above weight of the blockage ratio and slow speed ratio is adjustable according to actual needs. The weight of the blockage ratio is increased when the blockage ratio impacts user experience most seriously, and the weight of the slow speed ratio is increased when the slow speed ratio impacts user experience most serious. When both ratios have similar impact on the user experience considerably, the weights thereof are decreased by the same amount.

Quantitatively rating the service quality of edge node is more convenient to the practical application. In this embodiment, the service quality of edge node is rated in three levels, while it is not limited to the three levels in practice and can be set to any number of levels according to actual demand.

As there may exist a plurality of edge nodes serving for a certain partition in a historical data, and the service quality provided by different edge nodes may also be close (i.e., the weighted sum of the blockage ratio and slow speed ratio of a served video is close, thus falling within the same threshold range), different edge nodes will be classified into to the same level of service quality. Under this scenario, when a user accesses a video, the dispatching center selects a edge node closer to the user, which ensures service quality for the user, and also reduces the burden of the farther edge node serving for the user, and thus the edge node far away from the user can better serve the user close to it, which reaches an effect that the edge node can be fully and rationally utilized.

In some embodiments, the dispatching center establishes the mapping model between a user's priority level and the quality of service level as recited in S2 includes the following steps.

The dispatching center determines the priority of a user according to user sources information, user attribute information, and network service provider information.

The dispatching center establishes a matchup between the priority of the user and the service quality level of the edge node.

The dispatching center establishes the mapping model between a user's priority level and the quality of service level, so that the subsequent users' request information can be responded timely upon their accesses, and thus the reaction speed can be faster and services can be more timely, which ensures service quality and improve user experience.

The dispatch center determines service quality of edge node according to preset cycle and according to the weighted sum of the blockage ratio and slow speed ratio in any of the above embodiments. Because in the actual application, the network environment continuously changes, whilst software and hardware resources and the network architecture are also constantly upgraded, regularly evaluating the service quality of edge node ensures the real-time and effectiveness of the evaluation results, which can guarantee service quality to the user.

In some embodiments, determining priority for the user in S3 includes the following steps.

The dispatch center determines the user sources information and user attribute information.

When the user sources information is the specified mobile terminal or specified client, or when the user attribute information is a member user, the dispatching center determines that the user has a first priority;

When the user attribute information indicates that he/she is a non-member user, the dispatching center determines that the user has a second priority.

Specifically, dispatching high service quality to the user with high priority edge node includes:

dispatching the first-level edge node to the user with the first priority; and

dispatching the second-level or the third-level edge node to the user with the second priority.

In the present embodiment, users to different priorities according to user sources information and user attribute information to provide service with different qualities to them, and to achieve a personalized service based on customer needs.

It should be noted that, for the purpose of simplicity, each aforementioned method embodiment is described as a series of actions to merger, those skilled in the art should appreciate it that the present application is not limited to the described order of actions, because according to the present application, some additional steps may proceed sequentially or simultaneously. In addition, those skilled in the art will also be aware of that the embodiments described in the specification are preferred embodiments, and hence actions and modules involved therein are not necessarily essential to the application.

In the above embodiments, different emphasis is placed on respective embodiments, and hence for those portions without a detailed description in an embodiment, reference can be made to relevant portions in other embodiments.

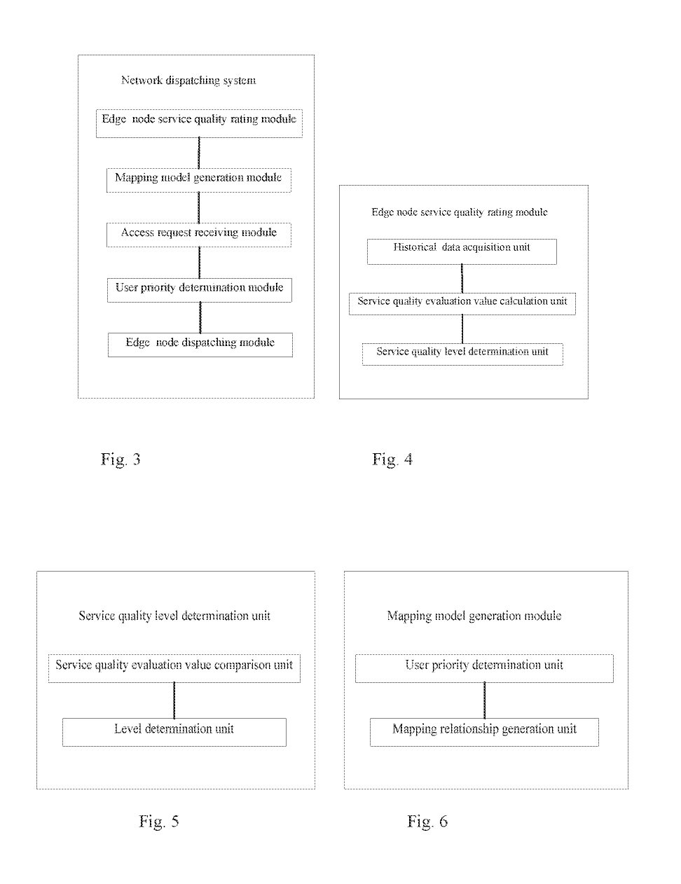

As shown in FIG. 3, according to another aspect of the present application, an embodiment of a system for network dispatching is provided, which include:

an edge node service quality rating module configured to determine a service quality level of all edge nodes serving for a partition with respect to a video according to historical data of a blockage ratio and slow speed ratio in accessing the video in the partition;

a mapping model generation module configured to establish a mapping model between a user's priority and the service quality level;

an access request receiving module configured to receive a request from a user in a partition for accessing a video;

a user priority determination module configured to determine a priority of the user based on mapping model established by the mapping model generation module and a request from a user received by the access request receiving module for accessing a video through an intelligent terminal;

an edge node dispatching module configured to determine an edge node having a corresponding service quality level for the user based on the priority of the user determined by the the user priority determination module and the mapping model established by the mapping model generation module.

In the above embodiment, priorities of edge nodes serving a video are classified by partition to make the network dispatching more pertinent. Meanwhile, edge node of corresponding priority is assigned in accordance with the user's priority to meet individual needs, thus ensuring a better user experience.

The system for network dispatching of the present embodiment is implemented as a dispatching center in the CDN system. The dispatching center may be a server or server cluster, wherein each module may be a single server or server cluster. As such, interactions among the modules are actually interactions among servers or server cluster to which each module corresponding, and multiply servers or server clusters together constitute the CDN dispatching system of the present application.

Specifically, the CDN dispatching system constituted by multiple servers or server clusters according to the present application includes:

an edge node service quality rating server or server cluster configured to determine a service quality level of all edge nodes serving for a partition with respect to a video according to historical data of a blockage ratio and slow speed ratio in accessing a video through an intelligent terminal by the user in the partition;

a mapping model generation server or server cluster configured to establish a mapping model between a user's priority and the service quality level determined by the edge node service quality rating server or server cluster;

an access request receiving server or server cluster configured to receive a request from the user in the partition for accessing the video through the intelligent terminal;

a user priority determination server or cluster of server configured to determine a priority of the user according to the mapping model established by the mapping model generation server or server cluster and the request that the user will access the video through the intelligent terminal which is received by the access request receiving server or server cluster; and

an edge node dispatching server or server cluster configured to determine an edge node having a corresponding service quality level for the user based on the priority of the user determined by the user priority determination server or cluster of server and the mapping model established by the mapping model generation server or server cluster.

In an alternative embodiment, the plurality of modules of several modules may together constitute a server or server cluster. For example: the edge node service quality rating module and the mapping model generation module together form a first server or a first server cluster, the access request receiving module forms a second server or a second server cluster, the user priority determination module and the edge node dispatching module together constitute a third server or a third server cluster.

In this case, interactions among the above modules are implemented as interactions among the first server to the third server or interactions among the first server cluster server to the third server cluster, and the first server to the third server or the first server cluster server to the third server cluster together constitute a CDN dispatching system of the present application. As shown in FIG. 4, in some embodiments, the edge node prioritization module includes:

a historical data acquisition unit configured to retrieve the historical data of a blockage ratio and slow speed ratio in accessing a video through an intelligent terminal by a user in a partition;

a service quality evaluation value calculation unit configured to assign corresponding weights to the historical data of blockage ratio and the historical data of the slow speed ratio obtained by the historical data acquisition unit for a weighted sum thereof to generate an service quality evaluation value; and

a service quality level determination unit configured to determine the service quality level of the edge node according to the service quality evaluation value determined by the service quality evaluation value calculation unit.

The edge node prioritization module of the present embodiment may be a server or server cluster, wherein each unit may be a single server or server cluster. As such, interactions among the modules are implemented as interactions among servers or server cluster to which each module corresponds, and multiply servers or server clusters together constitute the edge node prioritization module for constituting the CDN dispatching system of the present application.

In an alternative embodiment, several units of the above-mentioned plurality of units may together form a server or server cluster. The dispatching center in the above embodiment or the server in the dispatching center determines level of quality service of the edge node providing video service by weighted summing historical data of a blockage ratio and slow speed ratio in the user's accessing the video and then a comparison. Since the dispatching center in the present embodiment determines whether the service quality of edge node is good or not directly from the data information of user experience, the obtained evaluation of the service quality of the edge node is more reliable. Even if there are other factors affecting the user experience, the blockage ratio and slow speed ratio are still the final factors impacting the user experience falls. Therefore, the evaluation of service quality of the edge node obtained directly from the blockage ratio and slow speed ratio is objective and reliable.

As shown in FIG. 5, in some embodiments, the service quality level determination unit includes:

a service quality evaluation value comparison unit configured to determine by comparison whether the service quality evaluation value belongs to a first threshold value range, a second threshold value range, or a third threshold range;

a level determination unit configured to:

determine the edge node as a first level edge node when the service quality evaluation value comparison unit determines that the service quality evaluation value belongs to a first threshold value range;

determine the edge node as a second level edge node when the service quality evaluation value comparison unit determines that the service quality evaluation value belongs to a second threshold value range; and

determine the edge node as a third level edge node when the service quality evaluation value comparison unit determines that the service quality evaluation value belongs to a third threshold value range.

In this embodiment, the service quality level determination unit may be a server or server cluster, wherein the service quality evaluation value comparison unit and the level determination unit may be a single server or server cluster. As such, interactions among the service quality evaluation value comparison unit and the level determination unit are embodied as interactions among servers or server cluster to which each module corresponds.

In an alternative embodiment, both of the service quality evaluation value comparison unit and the level determination unit may together form a server or server cluster.

As shown in FIG. 6, in some embodiments, the mapping model generation module includes:

a user priority determination unit configured to determine the priority of the user according to user sources information, user attribute information, and network service provider information;

a mapping relationship generation unit configured to establish a matchup between the priority of the user and the service quality level of the edge node.

In any of the above embodiments, historical data of a blockage ratio and slow speed ratio in accessing the video are historical data in a predetermined period.

The mapping model generation module in the embodiment may be a server or server cluster, wherein each unit may be a single server or server cluster. As such, interactions among the above-mentioned units are interactions among servers to which each unit corresponds.

In an alternative embodiment, both of the user priority determination unit and the mapping relationship generation unit may together form a server or server cluster.

In the embodiments of the application, the relevant functional modules may be implemented by a hardware processor.

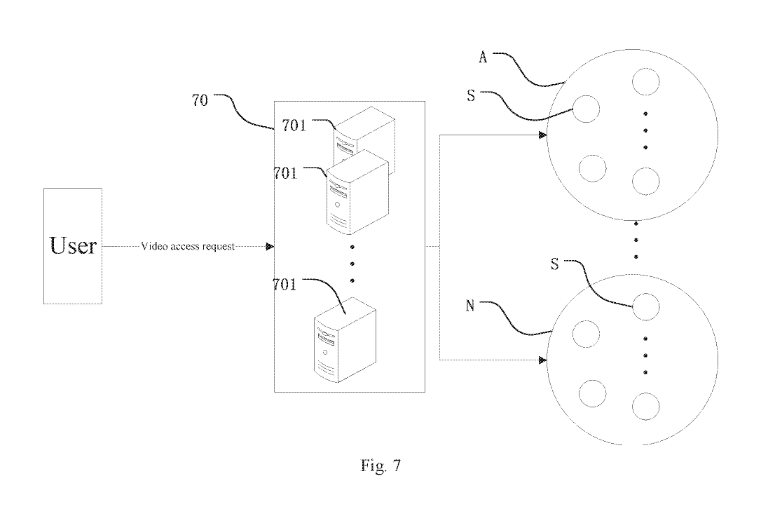

FIG. 7 is an architecture diagram showing the implementation of a method and system for network dispatching according to an embodiment of the present application, which includes a video dispatching center 70, and area A1 to area An. The dispatching center 70 includes a plurality of servers C₁˜Cᵢ. Each of areas A1 to An respectively includes a plurality of edge CDN nodes N. After the server in the dispatching center of the architecture diagram receives the video access request sent by a user through a client terminal (the client terminal is at least an intelligent terminal), implements the method for dispatching as shown in FIG. 1 of the present application to determine edge CDN nodes being able to provide the best server to the user.

An embodiment of the present application also provides a non-transitory computer-readable storage medium storing executable instructions that used to execute any one of methods of the present application as described above.

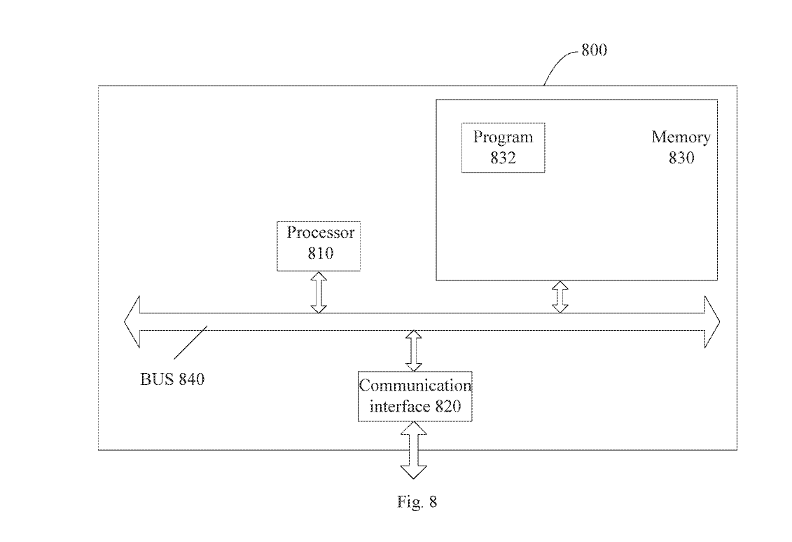

FIG. 8 shows a structural schematic diagram of an electronic device such as a server 800 for implementing the method for the network dispatching according to an embodiment of the present application, whilst the embodiment of the present application does not limit the specific implementation of the server 800. As shown in FIG. 8, the server 600 may include a processor 810, a communication interface 820, a memory 830, and a communication bus 840.

The processor 610, the communication interface 620, and memory 630 communicate with each other via the communication bus 640.

Communication interface 820 communicates with the network elements such as client ends.

Processor 810 executes program 832, and specifically, execute the related steps as described in the above method embodiment.

Specifically, program 832 may include program code, and the program code includes computer operation instructions.

Processor 810 may he a central processing unit CPU, or Application Specific Integrated. Circuit ASIC, or is configured to one or more integrated circuits for implementing the present embodiment of the application.

The server in the above-described embodiment include

a memory storing computer operation instructions;

a processor executing the computer operation instructions stored in the memory, to execute:

determine a service quality level of all edge nodes serving for a partition with respect to a video according to historical data of a blockage ratio and slow speed ratio in a user's access to the video in the partition;

establish a mapping model between a user's priority and the service quality level;

receive a request from a user in a partition for accessing a and determining the priority of the user; and

dispatch an edge node having a corresponding service quality level for the user based on the determined priority of the user and the mapping model.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the present application can be provided as method, system, or computer program product. Therefore, the present application can be implemented in various ways, such as purely by hardware, or purely by software, or a combination of software and hardware. Moreover, the present application can be implemented as a computer program product including one or more computer executable program codes which are stored on a computer readable memory medium (including but not limited to a disk storage or optic memory, etc.).

The present application is described in reference to method, device (or system), and flow chart and/or block diagram of computer program product of embodiment of the application. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the present application, but not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A method for network dispatching, comprising, at an electronic device,
determining a service quality level with respect to a video of all edge nodes serving for a partition according to historical data of a blockage ratio and slow speed ratio in accessing the video in the partition;
establishing a mapping model between a user's priority and the service quality level;
receiving a request from a user in the partition for accessing the video and determining the priority of the user; and
dispatching an edge node having a corresponding service quality level for the user based on a determined priority of the user and the mapping model.

2. The method for network dispatching of claim 1, wherein said determining a service quality level with respect to a video of all edge nodes serving for a partition according to historical data of a blockage ratio and slow speed ratio in accessing the video in the partition comprises:
retrieving the historical data of a blockage ratio and slow speed ratio in accessing the video in the partition, assigning corresponding weights to the historical data of blockage ratio and the historical data of the slow speed ratio, and conducting a weighted summing thereof to generate an service quality evaluation value; and
determining the service quality level of the edge node according to the service quality evaluation value.

3. The method for network dispatching of claim 2, wherein said determining the service quality level of the edge node according to the service quality evaluation value comprises:
determining the edge node as a first level edge node when the service quality evaluation value belongs to a first threshold value range;
determining the edge node as a second level edge node when the service quality evaluation value belongs to a second threshold value range;
determining the edge node as a third level edge node when the service quality evaluation value belongs to a third threshold value range; and
wherein an upper limit value of the first threshold value range is smaller than a lower limit value of the second threshold value range, an upper limit value of the second threshold value range is smaller than a lower limit value of the third threshold value range.

4. The method for network dispatching of claim 1., wherein said establishing the mapping model between a user's priority level and the service quality level comprises:
determining the priority of the user according to user sources information, user attribute information, and network service provider information; and
establishing a matchup between the priority of the user and the service quality of the edge node.

5. The method for network dispatching of claim 1, wherein said historical data of a blockage ratio and slow speed ratio in accessing the video are historical data in a predetermined period.

6. A non-transitory computer-readable storage medium storing executable instructions that, when executed by an electronic device, cause the electronic device to:
determine a service quality level with respect to a video of all edge nodes serving for a partition according to historical data of a blockage ratio and slow speed ratio in accessing the video in the partition;
establish a mapping model between a user's priority and the service quality level;
receive a request from the user in the partition for accessing the video and determine the priority of the user; and
dispatch an edge node having a corresponding service quality level for the user based on a determined priority of the user and the mapping model.

7. The non-transitory computer-readable storage medium according to claim 6, wherein the executable instructions that, when executed by an electronic device, further cause the electronic device to:
retrieve the historical data of a blockage ratio and slow speed ratio in accessing the video in the partition, assign corresponding weights to the historical data of blockage ratio and the historical data of the slow speed ratio, and conduct a weighted summing thereof to generate an service quality evaluation value; and
determine the service quality level of the edge node according to the service quality evaluation value.

8. The non-transitory computer-readable storage medium according to claim 7, wherein the executable instructions that, when executed by an electronic device, further cause the electronic device to:
determine the edge node as a first level edge node when the service quality evaluation value belongs to a first threshold value range;
determine the edge node as a second level edge node when the service quality evaluation value belongs to a second threshold value range;
determine the edge node as a third level edge node when the service quality evaluation value belongs to a third threshold value range; and
wherein an upper limit value of the first threshold value range is smaller than a lower limit value of the second threshold value range, an upper limit value of the second threshold value range is smaller than a lower limit value of the third threshold value range.

9. The non-transitory computer-readable storage medium according to claim 6, wherein the executable instructions that, when executed by an electronic device, further cause the electronic device to:
determine the priority of the user according to user sources information, user attribute information, and network service provider information; and
establish a matchup between the priority of the user and the service quality level of the edge node.

10. The non-transitory computer-readable storage medium according to claim 6, wherein said historical data of a blockage ratio and slow speed ratio in accessing the video are historical data in a predetermined period.

11. An electronic device, comprising:
at least one processor; and
a memory communicably connected with the at least one processor for storing instructions executable by the at least one processor, wherein execution of instructions by the at least one processor causes the at least one processor to:
determine a service quality level with respect to a video of all edge nodes serving for a partition according to historical data of a blockage ratio and slow speed ratio in accessing the video in the partition;
establish a mapping model between a user's priority and the service quality level;
receive a request from a user in the partition for accessing the video and determine the priority of the user; and
dispatch an edge node having a corresponding service quality level for the user based on the determined priority of the user and the mapping model.

12. The electronic device according to claim 11, wherein execution of the instructions by the at least one processor further causes the at least one processor to:
retrieve the historical data of a blockage ratio and slow speed ratio in accessing the video in the partition and assign corresponding weights to the historical data of blockage ratio and the historical data of the slow speed ratio to conduct a weighted summing thereof to generate an service quality evaluation value; and
determine the service quality level of the edge node according to the service quality evaluation value.

13. The electronic device according to claim 12, wherein execution of the instructions by the at least one processor further causes the at least one processor to:
determine the edge node as a first level edge node when the service quality evaluation value belongs to a first threshold value range;
determine the edge node as a second level edge node when the service quality evaluation value belongs to a second threshold value range;
determine the edge node as a third level edge node when the service quality evaluation value belongs to a third threshold value range; and
wherein an upper limit value of the first threshold value range is smaller than a lower limit value of the second threshold value range, an upper limit value of the second threshold value range is smaller than a lower limit value of the third threshold value range.

14. The electronic device according to claim 11, wherein execution of the instructions by the at least one processor further causes the at least one processor to:
determine the priority of the user according to user sources information, user attribute information, and network service provider information; and
establish a matchup between the priority of the user and the service quality level of the edge node.

15. The electronic device according to claim 11, wherein said historical data of a blockage ratio and slow speed ratio in accessing the video are historical data in a predetermined period.
